(19) United States
(12) Patent Application Publication
(10) Pub. No.: US 2019/0286261 A1
(43) Pub. Date: Sep. 19, 2019

(54) ZERO-GUARD CAPACITIVE DETECTION DEVICE

(71) Applicant: FOGALE NANOTECH, Nîmes (FR)

(72) Inventors: Christian NEEL, Nîmes (FR); Frédéric OSSART, Langlade (FR); Eric LEGROS, Ales (FR); Didier ROZIERE, Nîmes (FR)

(21) Appl. No.: 16/301,245

(22) PCT Filed: Apr. 25, 2017
(86) PCT No.: PCT/EP2017/059818

§ 371 Date: Nov. 13, 2018

(30) Foreign Application Priority Data
May 25, 2016 (FR) 1654667

(51) Int. Cl. G06F 3/044; G01D 5/24; G06F 3/041

(52) U.S. Cl. CPC G06F 3/044; G06F 2203/04107; G06F 3/0416; G01D 5/24

(57) ABSTRACT

A capacitive detection device includes: at least one capacitive measurement electrode; a current detector electrically referenced to a common ground; at least one alternating voltage excitation source electrically connected or coupled to a measurement input of the current detector and to the at least one capacitive measurement electrode; guard elements electrically connected or coupled to the measurement input of the current detector; power supply generation apparatus suitable for generating at least one secondary power supply source referenced to the electrical potential of the guard elements, the power supply generation apparatus also being arranged so as to have, within a frequency band extending from direct current, an impedance between the common ground and the guard elements with a reactive component of a capacitive or essentially capacitive type, or comparable to an open circuit.

### TECHNICAL FIELD

The present invention relates to a capacitive detection device for detecting the presence or the proximity of objects of interest. It also relates to an appliance comprising such a device.

The field of the invention is more particularly but non-limitatively that of capacitive detection systems.

### STATE OF THE PRIOR ART

Capacitive detection devices are widely used for measuring distances or for detecting the presence or the proximity of objects.

The general principle thereof consists of exploiting and measuring a coupling capacitance that is established between one or more capacitive measurement electrodes and objects that it is desired to detect. Knowledge of this capacitance makes it possible to deduce distances between the electrodes and the objects.

According to known techniques, the capacitive electrodes are excited at an excitation potential. When an object referenced to a common ground or to earth (which is the case for practically any object) is located close to an electrode, it establishes a coupling capacitance between this electrode and the object. This coupling capacitance can be measured by measuring the current flowing between the electrode and the common ground at the excitation frequency. To this end, a charge sensitive amplifier can be used, connected at the input to the electrode.

A problem that arises generally with this type of measurements is that the measurement electrodes and the electronics are equally sensitive to capacitive couplings that may be established with the environment. This is apparent through the appearance of parasitic leakage capacitances that are superimposed on the measurement capacitance and generate measurement errors.

A known solution to this problem is to add a guard that prevents parasitic couplings between the capacitive measurement electrodes and the environment, thus eliminating the parasitic leakage capacitances.

This guard can be electrically referenced to the common ground potential. In this case, the appearance of a parasitic leakage capacitance between the electrode and the guard is not prevented, but the assumption is made that this parasitic leakage capacitance is sufficiently stable over time to be calibrated. This type of configuration is thus limited in terms of accuracy of measurement and stability over time. Moreover, the need for periodic recalibration results in restrictions on use that may be inconvenient.

Measurement configurations are also known that utilize a guard known as an active guard. In this case the guard is excited at an electrical potential substantially identical to the potential of the measurement electrodes. This configuration has the advantage that any capacitive couplings that may be present between the guard and the electrodes do not produce leakage currents and therefore do not generate parasitic leakage capacitances, as there is no potential difference between the guard and the electrodes.

These “active guard” measurement configurations are widely used for producing measurement systems with a significant measurement sensitivity and range.

These systems are utilized in particular in the form of arrays of electrodes making it possible to render surfaces sensitive to their environment, for example to produce anti-collision systems.

Document WO 2004/023067 is known for example, which describes a proximity detector that can be used in particular as an anti-collision system for medical equipment. This document utilizes a capacitive measurement method that constitutes a variant of the “active guard” measurement configuration in which a part of the detection electronics is also referenced to the guard potential in order to eliminate the parasitic leakage capacitances completely.

These “active guard” measurement configurations have excellent measurement performances that justify the widespread use thereof. Nevertheless the integration thereof into complex electronic systems can prove problematic from the point of view of electromagnetic compatibility, due to the presence of the guard elements polarized at the excitation potential.

Document FR 337 346 is also known, which describes a high-precision capacitive measurement method that has the advantage of utilizing a guard at a potential substantially equivalent to the common ground potential of the detection electronics. However, this long-standing measurement method is limited to differential measurement with a single electrode, and relies on a configuration based on a differential transformer and inductance coils that are incompatible with utilization in integrated electronics. Moreover, due to the means of transferring a power supply into the guarded part, the guard only provides effective protection against the parasitic capacitances within a narrow frequency band associated with a resonance, which renders the implementation of this measurement method difficult.

A purpose of the present invention is to propose a capacitive measurement device with measurement sensitivity and immunity to the parasitic leakage capacitances and their variations that allow the detection and measurement of distances or contact with objects of interest within a significant measurement range.

Another purpose of the present invention is to propose a capacitive measurement device capable of managing a plurality or a large number of electrodes.

Another purpose of the present invention is to propose a capacitive measurement device that generates a minimum of electromagnetic disturbances, so as to be capable of easy integration into a complex electronic environment.

Another purpose of the present invention is to propose a capacitive measurement device that is compatible with production in the form of integrated electronics components.

### DISCLOSURE OF THE INVENTION

This objective is achieved with a capacitive detection device comprising:
at least one capacitive measurement electrode;
a current detector electrically referenced to a common ground and sensitive to an electric current flowing over a measurement input;
at least one alternating voltage excitation source electrically connected or coupled to the measurement input of the current detector and to the at least one capacitive measurement electrode;
guard elements electrically connected or coupled to the measurement input of the current detector;
characterized in that it also comprises power supply generation means suitable for generating at least one secondary power supply source referenced to the electrical potential of the guard elements, said power supply generation means also being arranged so as to have, within a frequency band extending from direct current, an impedance between the common ground and the guard elements with a reactive component of a capacitive or essentially capacitive type, or comparable to an open circuit.

The reactive component of the impedance corresponds to the imaginary part thereof.

According to embodiments, the power supply generation means can:
be partially referenced to the common ground potential, or comprise elements referenced to the common ground potential. In this case they can in particular be arranged so as to use power from one or more primary power supply sources referenced to the common ground potential in order to generate one or more secondary power supply sources referenced to the electrical potential of the guard elements.
not comprise elements referenced to the common ground potential. In this case they can comprise one or more secondary power supply sources referenced to the electrical potential of the autonomous guard elements, such as for example batteries, cells or photovoltaic elements.

According to embodiments, the impedance of the power supply generation means between the common ground and the guard elements can comprise, at least in a frequency band extending from direct current:
an imaginary part (or a reactive component) corresponding or corresponding essentially to a serial capacitance between the common ground and the guard elements.
an imaginary part (or a reactive component) characterized by an absence of a significant inductive component;
a value or a module that is of the same order of magnitude, or greater, than the impedance value of the parasitic coupling capacitances between the common ground and the guard elements;
a value or a module greater than 1 kOhm, or 10 kOhm, or 1 MOhm at 100 KHz, with a zero or non-zero active component (real part).

Non-limitatively, the frequency band extending from direct current can extend from direct current to 1 KHz, or 10 KHz, or 200 KHz, or 1 MHz.

The parasitic coupling capacitances between the common ground and the guard elements can be for example of the order of 400 pF, which corresponds to an impedance value or module of 4 kOhm to 100 kHz.

The parasitic coupling capacitances can of course have a very different value according to the embodiments of the invention and the environment thereof. But by definition they introduce an impedance between the common ground and the guard elements with a reactive component of a capacitive or essentially capacitive type, the modulus of which decreases as the frequency increases.

The presence of the power supply generation means potentially causes the appearance of an impedance between the common ground and the guard elements, different by definition from that due to the parasitic coupling capacitances, and in parallel with these parasitic coupling capacitances. In order to avoid the appearance of significant additional leakage currents, it is preferable for this impedance from the power supply generation means to be, as explained above, of the same order of magnitude, or greater, than the impedance value of the parasitic coupling capacitances between the common ground and the guard elements.

Moreover, it is preferable for this condition to be satisfied within a broad frequency range in order to be able to utilize an alternating voltage excitation source at any frequency, or in any form, or as explained below, in order to be able to utilize several alternating voltage excitation sources at different frequencies.

The solution of the invention is to utilize power supply generation means arranged so as to have, within a frequency band extending from direct current, i.e. in particular or at least for low frequencies comprised within one or more of the aforementioned ranges, an impedance between common ground and the guard elements with a reactive component of a capacitive or essentially capacitive type, or similar to an open circuit. In this way, the impedance of the power supply generation means develops as a function of the frequency in the same direction as that due to the parasitic capacitances (or remains stable and very high) within a broad frequency range.

It should be noted that by utilizing an impedance between the common ground and the guard elements with a reactive component of an inductive or essentially inductive type (such as for example described in document FR 2 337 346), the impedance of the power supply generation means would necessarily be much lower than that due to the parasitic coupling capacitances for the low frequencies, or for frequencies below a resonance frequency of the circuit constituted by the inductance coil and the coupling capacitors.

An impedance similar to an open circuit can be defined as an impedance the value or the modulus of which is very high (for example at least 10 or 100 times greater) with respect to the other impedances that affect measurement, or at least that is sufficiently high in order to be approximated by an open circuit or an infinite impedance. This impedance can comprise a zero or non-zero active component (real part).

The current detector(s) can comprise any electronic circuit making it possible to measure a variable representative of a current flowing over the measurement input thereof, or between the measurement input and the common ground to which the current detector is referenced. Such a current detector has in particular a negligible, or at least very low, impedance between the measurement input and the common ground.

The guard elements can be arranged so as to protect the at least one alternating voltage excitation source and the at least one capacitive measurement electrode from the parasitic capacitive couplings with the environment, or in other words to avoid the appearance of parasitic leakage capacitances to elements referenced to the common ground potential in particular.

The alternating voltage excitation source and the guard elements can be for example:
directly connected to the measurement input of the current detector, for example by a connecting track;
connected to the measurement input of the current detector (or in this case coupled) via electronic components such as capacitors and/or resistors.

The alternating voltage excitation source and the guard elements can in particular be coupled to the measurement input of the current detector via a linking capacitor placed in series between the alternating voltage excitation source and the guard elements on the one hand and the measurement input of the current detector on the other hand. This configuration makes it possible to reduce the coupling, in the current detector, of the noise generated by the electromagnetic interference detected by the guard elements.

According to embodiments, the device according to the invention can comprise power supply generation means with electrical switching means.

The electrical switching means can be in particular one of the following types: commutators, relays, switches, transistors, diodes, PN junctions.

The device according to the invention can in particular comprise power supply generation means with:
a first storage capacitor;
a second storage capacitor connected by a terminal to the guard elements; and
at least two supply commutators arranged so as to connect the terminals of the first storage capacitor respectively either to a primary power supply source referenced to the common ground potential, or to the terminals of the second storage capacitor.

The supply commutators can comprise respectively, electrical switching means. They can be produced in particular in the form of electronic switches.

In this embodiment, the means for generating a power supply are constituted by a charging pump. The second storage capacitor makes it possible to produce a secondary power supply source referenced to the electrical potential of the guard elements. The first storage capacitor makes it possible to replicate the voltage of the primary power supply source in an entirely floating manner. The supply commutators are arranged in order to operate synchronously and periodically, so as to alternately connect the first storage capacitor to the primary power supply source then to the second storage capacitor. These supply commutators are also arranged so that there is never a direct electrical connection between the terminals of the primary power supply source and the second storage capacitor.

Thus, the impedance of the power supply generation means corresponds theoretically to an open circuit.

In practice, the electronic switches comprise serial parasitic capacitances, for example of the order of a picofarad. Consequently the impedance of the power supply generation means is never infinite, but to the extent that these parasitic capacitances are significantly lower than the other parasitic coupling capacitances between the common ground and the guard elements, this impedance is comparable to an open circuit.

According to embodiments, the device according to the invention can comprise a current detector with a charge sensitive amplifier.

According to embodiments, the device according to the invention can comprise an alternating voltage excitation source with at least one of the following elements:
analogue and/or digital electronic excitation means referenced to the potential of the guard elements;
an oscillator;
a digital-to-analogue converter;
a signal generator of the pulse width modulation type;
a signal generator of the sub-sampling of a master signal type;
an FGPA
an amplifier or an excitation follower referenced to the potential of the guard elements, and arranged in order to receive at the input a master excitation signal referenced to the common ground potential.

The alternating voltage excitation source can thus generate an excitation signal referenced to the potential of the guard elements. This excitation signal can comprise for example a signal having a sinusoidal, triangular, trapezoid or square-wave form.

Sub-sampling a master signal makes it possible to generate for example a plurality of sinusoidal excitation signals from a high-frequency sinusoidal master signal, by spectrum folding using sampling frequencies that do not satisfy the Nyquist-Shannon sampling theorem.

The excitation signal can also comprise a binary signal of the pulse width modulation (PWM) type, making it possible to generate an analogue signal by filtering, for example triangular or sinusoidal.

According to embodiments, the device according to the invention can comprise an alternating voltage excitation source with an excitation commutator arranged so as to electrically connect a capacitive measurement electrode either to a secondary power supply source, or to the guard elements or to the measurement input of the current detector.

The excitation commutator can be arranged in order to switch over repetitively, so as to generate on the capacitive measurement electrode an alternating excitation signal alternating between two voltage levels.

This alternating excitation signal can comprise for example a periodic binary signal, a periodic binary signal following a time sequence, or a pulse width modulation (PWM) type signal making it possible to generate an analogue signal by filtering, for example triangular or sinusoidal.

According to embodiments, the device according to the invention can comprise a plurality of capacitive measurement electrodes and commutators making it possible to sequentially connect said capacitive measurement electrodes to the measurement input of the current detector, said commutators being arranged according to one of the following configurations:
the commutators are placed between the measurement electrodes and an alternating voltage excitation source connected to the measurement input of the current detector;
the commutators are placed between alternating voltage excitation sources connected respectively to a measurement electrode and the input of the current detector;
the commutators are placed in alternating voltage excitation sources connected respectively to a measurement electrode or form part of said sources.

According to embodiments, the device according to the invention can comprise a plurality of capacitive measurement electrodes and a plurality of alternating voltage excitation sources respectively connected to the capacitive measurement electrodes and to the measurement input of the current detector.

Thus, the capacitive measurement electrodes can be excited respectively by different alternating voltage excitation sources. These alternating voltage excitation sources can be connected to one and the same measurement input of the current detector.

In the event that several alternating voltage excitation sources are activated simultaneously, the electric current flowing over the measurement input of the current detector corresponds substantially to the sum of the currents flowing in the measurement electrodes, said currents depending respectively on the excitation signals generated by the alternating voltage excitation sources.

According to embodiments, the device according to the invention can comprise:
a plurality of alternating voltage excitation sources produced in the form of separate components; and/or
at least one electronic component grouping several or all of the alternating voltage excitation sources. This electronic component can comprise for example an integrated circuit such as an FGPA.

According to embodiments, the device according to the invention can comprise a plurality of alternating voltage excitation sources arranged so as to generate excitation signals at frequencies that are different, and/or orthogonal to one another.

Thus, the measurement signals originating from the measurement electrodes are coded differently and can be distinguished.

When excitation signals at different frequencies are used, each current originating from a capacitive measurement electrode has a different frequency content than that of the other electrodes. Thus a frequency multiplexing of the measurements originating from the capacitive electrodes is produced.

Orthogonal signals are defined as being signals the scalar product of any two of which over a number of samples or a predetermined duration is zero or almost zero (with respect to the modulus of these signals, i.e. the scalar product of these signals with themselves). Moreover, the conventional definition is used of a scalar product in a vector space provided with an orthonormal basis as being the sum of the products term-by-term of the samples of the signals within the predetermined duration.

The use of orthogonal excitation signals associated with a synchronous detection as explained below makes it possible to demodulate the measurements originating from the different capacitive electrodes independently, while minimizing the effects of crosstalk between measurement paths.

It should be noted that in general, excitation signals at different frequencies are not orthogonal to one another. They can however be orthogonal to one another where they have frequencies that mutually correspond to multiple integers.

According to embodiments, the device according to the invention can also comprise demodulation means with at least one of the following elements:
a synchronous demodulator arranged in order to demodulate, with a carrier signal, a modulated measurement signal originating from the current detector;
an amplitude detector;
a digital demodulator.

Generally, a synchronous demodulator can be modelled by (or comprise) a multiplier which carries out a multiplication of the measurement signal originating from the current detector with the carrier signal and a low-pass filter.

An amplitude detector (or asynchronous demodulator) can be modelled by (or comprise) a rectifier element, such as a diode rectifier, commutators with switches or a quadratic detector, and a low-pass filter. It makes it possible to obtain the amplitude of the modulated measurement signal originating from the current detector.

The demodulation means can also comprise band-pass or low-pass anti-folding filters placed before the demodulation.

Of course, the demodulation means can be produced in digital and/or analogue form. They can in particular comprise an analogue-to-digital converter and a microprocessor and/or an FGPA which carries out a synchronous demodulation, a detection of amplitude or any other demodulation operation digitally.

According to embodiments, the device according to the invention can comprise a plurality of alternating voltage excitation sources connected to the measurement input of the current detector and suitable for generating a plurality of excitation signals, and a plurality of synchronous demodulators arranged in order to demodulate a modulated measurement signal originating from the current detector with different carrier signals, said carrier signals and said alternating excitation voltages being paired such that a carrier signal makes it possible to selectively demodulate a measurement signal generated by a single alternating voltage excitation source.

The carrier signals and the alternating excitation voltages can be paired in the frequency domain (i.e. comprise common frequencies) and/or in the temporal domain (i.e. in phase and/or with similar temporal forms or structures). The carrier signals and the alternating excitation voltages can in particular be substantially identical or proportional, at least for their components at at least one frequency of interest.

According to embodiments, the device according to the invention can utilize a plurality of carrier signals at frequencies that are different, and/or orthogonal to one another.

According to embodiments, the device according to the invention can comprise at least one alternating voltage excitation source arranged so as to generate an excitation signal having one of the following forms: sinusoidal, square-wave, and at least one synchronous demodulator with a carrier signal having one of the following forms: sinusoidal, square-wave.

It can comprise in particular:
at least one alternating voltage excitation source arranged so as to generate a square-wave excitation signal, and at least one synchronous demodulator with a sinusoidal carrier signal having a frequency identical to the fundamental frequency of the excitation signal;
at least one alternating voltage excitation source arranged so as to generate a pulse width modulated (PWM) square-wave excitation signal, so as to correspond to a sinusoidal signal, and at least one synchronous demodulator with a sinusoidal carrier signal having a frequency identical to the frequency of the sinusoidal excitation signal.

According to embodiments, the device according to the invention can comprise signal transfer means suitable for generating a signal referenced to the common ground potential based on a signal referenced to the electrical potential of the guard elements, or conversely, said signal transfer means comprise at least one of the following elements:
a follower amplifier produced in the form of an inverting charge amplifier (for example with an input capacitor and a negative feedback capacitor);
an electronic assembly suitable for generating a compensation current between the common ground potential and the electrical potential of the guard elements having a value substantially identical and polarity opposite to a leakage current.

The leakage current can in particular be due to the transfer of the signals by the signal transfer means.

According to embodiments, the device according to the invention can comprise:
an integrated circuit incorporating at least the at least one alternating voltage excitation source, and at least a part of the guard elements;
an integrated circuit with guard elements produced in the form of a guard well electrically isolated from the substrate of said integrated circuit, said guard well comprising the at least one alternating voltage excitation source;
an integrated circuit with a substrate referenced to the common ground, and a current detector produced on said substrate.

The device according to the invention can in particular comprise an integrated circuit with a guard well electrically isolated from the substrate by one of the following means:
a succession of layers of semi-conductor material with P-type and N-type doping;
at least one layer of insulating materials.

Thus, the device according to the invention can be produced in a form suitable for the incorporation thereof into various appliances.

Production in the form of an integrated circuit is made possible in particular by the use of components excluding inductances or transformers with a high inductance value.

Production in the form of an integrated circuit also makes it possible to produce the guard elements particularly efficiently and optimally protect the alternating voltage excitation source or sources.

According to another aspect, an appliance is proposed comprising a capacitive detection device according to the invention.

According to embodiments, the appliance according to the invention can comprise a plurality of capacitive electrodes arranged along a surface of said appliance.

The appliance can be in particular a robot, a medical appliance for analysis or imaging or any other system with a sensitive surface. The capacitive electrodes can in particular be used for detecting a presence, an approach (anti-collision), a distance, a contact, or to allow interaction with the appliance or for the control thereof.

According to embodiments, the appliance according to the invention can comprise a plurality of capacitive electrodes superimposed on, or incorporated into, a display screen.

The display screen with the capacitive electrodes can then constitute a command interface, or a human-machine interface, for example for controlling medical or industrial equipment, etc.

### DESCRIPTION OF THE FIGURES AND EMBODIMENTS

Other advantages and characteristics of the invention will become apparent on reading the detailed description of implementations and embodiments that are in no way limitative, and from the following attached drawings:

FIG. 1 shows a first embodiment of the device according to the invention,

FIG. 2 shows a second embodiment of the device according to the invention,

FIG. 3 shows a third embodiment of the device according to the invention,

FIG. 4 shows a fourth embodiment of the device according to the invention,

FIG. 5 shows a fifth embodiment of the device according to the invention,

FIG. 6 shows a sixth embodiment of the device according to the invention,

FIG. 7 shows a seventh embodiment of the device according to the invention,

FIG. 8 shows an eighth embodiment of the device according to the invention,

FIG. 9 shows a ninth embodiment of the device according to the invention,

FIG. 10 shows an embodiment of the invention in the form of an integrated circuit.

It is well understood that the embodiments that will be described hereinafter are in no way limitative. Variants of the invention can be considered comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In particular, all the variants and all the embodiments described can be combined together if there is no objection to this combination from a technical point of view.

For reasons of clarity and brevity, the figures show only those elements necessary for understanding the invention. In the figures, the elements common to several figures retain the same reference.

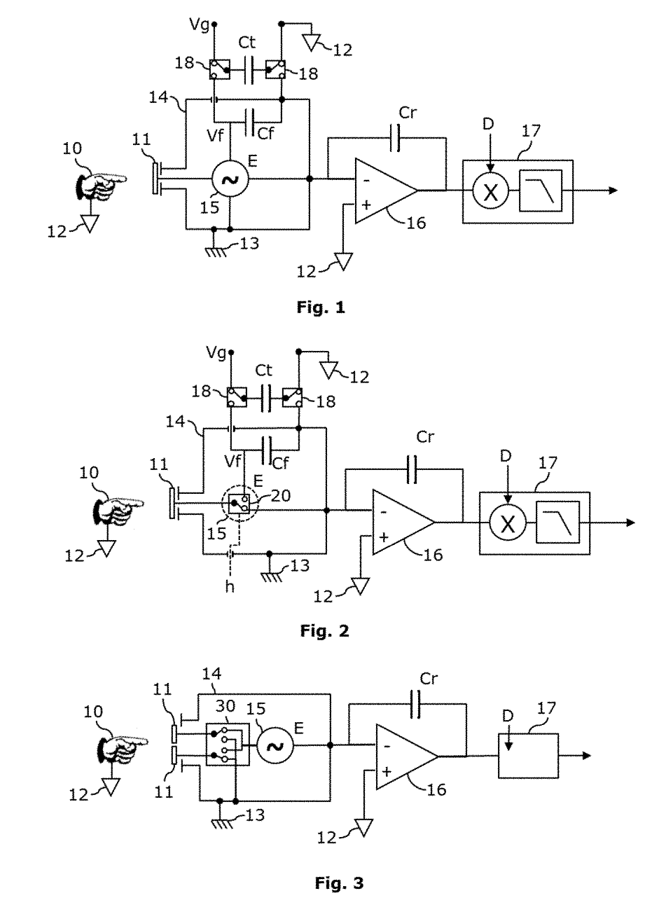

With reference to FIG. 1, a first embodiment of the capacitive detection device according to the invention will be described.

The purpose of the device is to detect and/or measure a capacitive coupling between one or more objects of interest 10 and a capacitive measurement electrode 11. On principle, it is assumed that the object(s) of interest 10 are referenced to a common ground 12 of the electronics, which can be earth. According to the applications, this or these object(s) of interest 10 can be a part of the human body (a head, a hand, a finger) or any other object.

The measurement of the coupling capacity between the object(s) of interest 10 and the capacitive measurement electrode 11 can be used for example for obtaining an item of information of contact, distance or location, or simply for detecting the presence of this or these objects.

The measurement electrode 11 is polarized at an excitation voltage or an excitation signal E by an alternating voltage excitation source 15 connected at the output to this measurement electrode 11. In the presence of an object of interest 10, a current is established in the measurement electrode 11 that depends on the capacitive coupling with this object of interest 10. This current is measured by a current detector 16 with a measurement input to which the measurement electrode 11 is connected via the alternating voltage excitation source 15. In the embodiment presented, this current detector 16 is formed from a charge sensitive amplifier 16 shown in the form of an operational amplifier with a measurement input on the (−) terminal thereof and a negative feedback capacitor Cr. The charge sensitive amplifier 16 is referenced to the common ground 12. At the output thereof it produces a measurement signal in the form of a measurement voltage Vm proportional to the capacitance Cm between the measurement electrode 11 and the object of interest 10:

Vm=−E Cm/Cr.

In the embodiment presented, the measurement signal is then demodulated by a demodulator 17 in the form of a synchronous demodulator 17 in order to obtain a representative value of the capacitance Cm (and/or of the distance of the object of interest 10). The synchronous demodulator is represented diagrammatically by a multiplier or a mixer that carries out a multiplication of the measurement signal Vm by a carrier signal D, and a low-pass filter.

As will be detailed below, the carrier signal D can be substantially identical to the excitation signal E, or at least matching this excitation signal E so as to have common frequency and/or temporal characteristics.

The device according to the invention also comprises guard elements 14 electrically connected to the measurement input of the current detector 16, or, in the embodiment presented, the (−) terminal of the charge sensitive amplifier 16. As the (+) terminal of the charge sensitive amplifier is connected to the common ground potential 12, these guard elements are thus referenced to a guard potential 13 substantially identical or identical to the common ground potential 12, but without being connected directly thereto.

The guard elements 14 can comprise all materials that are sufficiently electrically conductive. They are arranged, electrically and spatially, so as to protect at least the capacitive measurement electrode 11 and the alternating voltage excitation source 15 from the parasitic capacitive couplings with the outside.

In practice, these guard elements 14 can comprise, non-limitatively, a guard plane arranged close to the measurement electrodes 11 along a face opposite to a measurement zone, and guard tracks arranged along the linking tracks to the measurement electrodes 11. They can also comprise an enclosure surrounding the alternating voltage excitation source 15, produced for example in the form of a box enclosing the electronic components (when produced in a separate or semi-integrated form).

As explained previously, the purpose of the guard elements 14 is to eliminate all the parasitic capacitive couplings between the measurement electrode 11, the alternating voltage excitation source 15 and the common ground 12. In fact, these parasitic capacitive couplings that may appear in the absence of guard elements 14 according to the invention would generate leakage currents that would be directly added to the current to be measured at the input of the charge sensitive amplifier 16. Furthermore, the parasitic capacitance that can appear between the guard elements 14 and the common ground 12 does not generate a leakage current as the common ground potential 12 and the guard potential 13 are identical.

The alternating voltage excitation source 15 is referenced to the guard potential 13. Thus, the parasitic capacitances that can appear between the output of this alternating voltage excitation source 15 and the guard elements 14 generate leakage currents that are looped back into the guard elements 14 and do not contribute to the current measured by the charge sensitive amplifier 16.

Thus, by means of the invention, a high-quality guard is obtained that eliminates parasitic capacitive couplings and thus allows high-precision measurements. This guard also has the advantage of being at a potential similar to the common ground potential 12, and thus does not generate electromagnetic disturbances in the environment thereof. Finally, it relates to only a small part of the electronics, since the charge sensitive amplifier 16 and all the processing electronics are outside the zone protected by the guard elements 14.

The device according to the invention also comprises supply generation means that make it possible to generate one or more secondary power supply sources referenced to the guard potential 13 from primary power supply sources referenced to the common ground potential 12.

In the embodiments presented, these supply generation means are arranged in order to generate a secondary power supply source Vf from a primary DC power supply source Vg.

This or these secondary power supply sources make it possible in particular to supply the electronic components referenced to the guard potential 13, such as the alternating voltage excitation source 15.

As explained previously, the supply generation means must be arranged so as to have a very high impedance between the guard potential 13 and the common ground 12, at least in the frequency band used for the measurements (i.e. for example between 10 kHz and 200 kHz). This makes it possible to avoid leakage currents between the guard potential 13 and the common ground 12 that would be directly added to the current to be measured originating from the measurement electrode 11 at the input of the charge sensitive amplifier 16.

In the embodiments presented, the supply generation means are produced in the form of a charging pump. They comprise a first storage capacitor Ct, a second storage capacitor Cf connected via a terminal to the guard potential 13, and two supply commutators 18 arranged so as to connect the terminals of the first storage capacitor Ct respectively either to a primary power supply source Vg referenced to the common ground potential 12, or to the terminals of the second storage capacitor Cf.

The supply commutators 18 comprise electronic switches, produced for example with commutation transistors of the MOS or FET type). They are actuated synchronously and periodically, in two phases. Thus, they are arranged so that there is never direct electrical connection between the terminals of the primary power supply source Vg and the second storage capacitor Cf (unless via parasitic capacitances that are very low and thus have very high impedance).

In a first phase, the supply commutators 18 are actuated so as to connect the terminals of the first storage capacitor Ct respectively to the primary power supply source Vg and to the common ground 12. Thus, the voltage of the primary power supply source Vg is replicated at the terminals of the first storage capacitor Ct.

In a second phase, the supply commutators 18 are actuated so as to connect the terminals of the first storage capacitor Ct to the terminals of the second storage capacitor Cf, one of which is connected to the guard potential 13. In this way, the voltage at the terminals of the first storage capacitor Ct (corresponding to Vg) is replicated at the terminals of the second storage capacitor Vf.

Thus, at the terminals of the second storage capacitor Cf, a secondary power supply source Vf is generated, referenced to the guard potential 13, which replicates the first power supply source Vg. Switching of the supply commutators 18 is carried out with sufficient frequency so that the voltage Vf at the terminals of the second storage capacitor Cf does not vary too much as a function of the current consumed by the elements supplied in this way.

The alternating voltage excitation source 15 can be produced in any possible way.

It can comprise for example an oscillator, or a digital-to-analogue converter, or a signal generator utilized for example with an FGPA.

FIG. 2 shows an embodiment with an alternating voltage excitation source produced with an excitation commutator 20. This embodiment has the advantage of being simple to implement.

The excitation commutator 20 is arranged so as to electrically connect a capacitive measurement electrode 11 alternately to the secondary power supply source Vf, and to the guard potential 13. Thus, an excitation signal E is generated between the capacitive measurement electrode 11 and the measurement input of the current detector 16, which alternates between a value of zero and the secondary supply voltage Vf.

In the embodiment presented, the excitation commutator 20 is driven by an external command signal h.

The excitation signal E thus generated can comprise for example a periodic binary signal, a periodic binary signal following a time sequence, or a pulse width modulation (PWM) type signal making it possible to generate an analogue signal by filtering, for example triangular or sinusoidal.

FIG. 3 shows an embodiment that makes it possible to utilize a plurality of capacitive measurement electrodes 11 in order to carry out measurements sequentially with one and the same charge sensitive amplifier 16.

In this embodiment, the device comprises a commutator 30 placed between an alternating voltage excitation source 15 and a plurality of measurement electrodes 11, and which makes it possible to select a particular measurement electrode 11. The commutator 30 is arranged so that each measurement electrode 11 is connected, either to the alternating voltage excitation source 15 in order to allow a measurement, or to the guard potential 13 that contributes to the guard elements 14. This embodiment thus allows sequential measurements on the measurement electrodes 11.

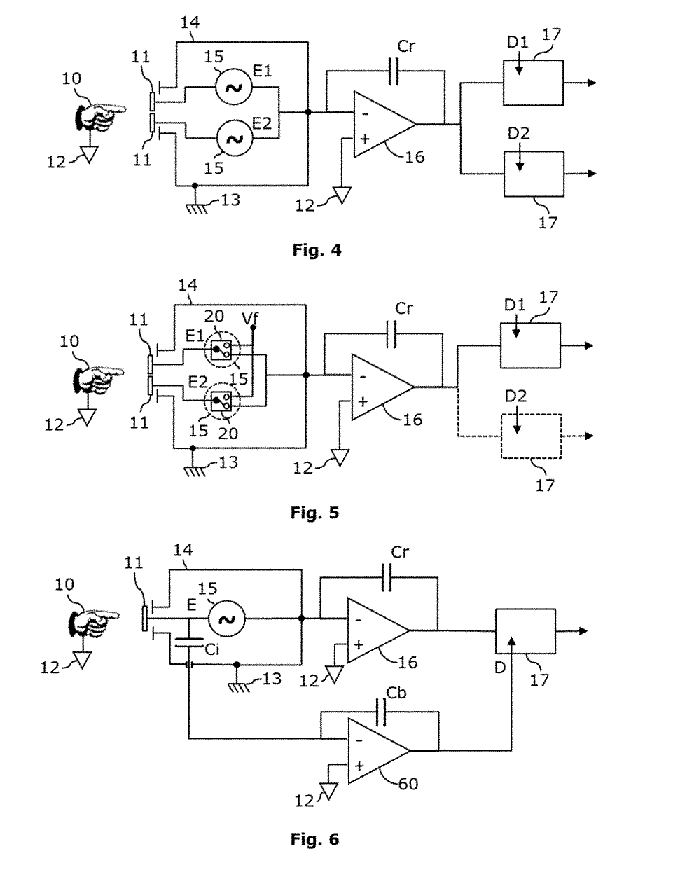

FIG. 4 shows an embodiment that makes it possible to utilize a plurality of capacitive measurement electrodes 11 in order to carry out measurements simultaneously with one and the same charge sensitive amplifier 16.

In this embodiment, the device comprises a plurality of alternating voltage excitation sources 15, each connected to a different measurement electrode 11. The alternating voltage excitation sources 15 are all connected in parallel to the input of the charge sensitive amplifier 16.

The charge sensitive amplifier 16 is connected at the output to a plurality of demodulators 17. These demodulators 17 thus receive at the input a composite signal corresponding to the set of measurements carried out on the measurement electrodes 11 connected to the input of the charge sensitive amplifier.

In order to be able to carry out measurements simultaneously on the measurement electrodes 11, arrangements are made for each demodulator 17 to be able to selectively demodulate the measurement signal originating from a single measurement electrode 11.

To this end:
the alternating voltage excitation sources 15 are arranged in order to generate different excitation signals E1, E2, etc. on each of the measurement electrodes;
synchronous demodulators are utilized that each use a different carrier signal D1, D2, etc. paired with a single excitation signal E1, E2, etc.

Certain conditions must also be respected for the signals in order to avoid crosstalk between measurement paths.

For example, carrier signals D1, D2, etc. can be utilized that are orthogonal to one another and orthogonal to the excitation signals E1, E2, etc. with the exception of a single one with which each carrier signal is paired:

Di·Dj=0 for i≠j

Di·Ej=0 for i≠j

This orthogonality can for example be defined in the sense of the scalar product, the latter corresponding to the sum of the products of the values of the signals over a period of time.

According to a preferential embodiment, a frequency modulation is carried out:
excitation signals E1, E2, etc. are utilized, offset in frequency by a quantity greater than the pass-band necessary for the measurement; and
carrier signals D1, D2, etc. are used, corresponding respectively to the excitation signals E1, E2, etc. or at least to signals at the respective fundamental frequency of the excitation signals E1, E2, etc.

An advantageous way of producing this frequency multiplexing is to utilize an integrated circuit, for example of the FPGA type, which in the form of a single component produces all the alternating voltage excitation sources 15. This integrated circuit is of course referenced to the guard potential 13.

A pulse width modulation (PWM) technique, well known to a person skilled in the art, is utilized to generate excitation signals E1, E2, etc. of a sinusoidal type and offset in frequency. In this case the excitation signals correspond to digital signals oscillating between two values, but of which the cyclical ratio is modulated sinusoidally for example. Their frequency spectrum then comprises a beam at the frequency of the sinusoidal signal and high-frequency energy that is naturally filtered by the limited pass-band of the system. The advantage of such a technique is that it can be implemented with simple digital electronic means and makes it possible to generate harmonic signals with very little distortion, at least within the frequency band of interest.

The carrier signals D1, D2, etc. used correspond to the sinusoidal signals generated.

FIG. 5 shows a variant of the embodiment shown in FIG. 4 in which the alternating voltage excitation sources 15 are produced with excitation commutators 20, as explained in relation to FIG. 2.

As previously, the alternating voltage excitation sources 15 can advantageously be produced in the form of an integrated circuit.

This embodiment makes it possible to implement excitation signals E1, E2, etc. of the digital type, orthogonal to one another as previously described or offset in frequency in order to carry out simultaneous measurements on all the measurement paths.

It also makes it possible to implement the pulse width modulation (PWM) technique described in relation to FIG. 4 in order to generate excitation signals E1, E2, etc. of the sinusoidal type and offset in frequency.

A problem common to most of the embodiments is that it is necessary to transmit signals or information between the parts of the electronics referenced to the guard potential 13 and the parts of the electronics referenced to the common ground 12, without generating significant leakage currents, which as explained previously, contribute directly to measurement errors.

This transmission of signals is necessary in particular for synchronizing the alternating voltage excitation sources 15 and the demodulators 17. Thus the embodiments described hereinafter for the transmission of signals relate to this particular problem, it being understood that they are applicable to the transmission of all types of signals.

An ideal solution is to use a galvanic isolation coupling like a transformer or an opto-coupler (optical coupling transmitter-receiver), but these two techniques are difficult to incorporate into an integrated circuit.

With reference to FIG. 6 and FIG. 7, it is also possible to use transfer circuits with a very high input impedance.

For example, in order to transmit a signal referenced to the guard potential 13 to the electronics referenced to the common ground 12, it is possible to use a circuit referenced to the common ground 12 with a very high input impedance.

This solution is shown in FIG. 6. In this embodiment, the excitation signal E originating from an alternating voltage excitation source 15 (or any control signal whatever originating from this source) is transmitted to a follower amplifier 60 referenced to the common ground 12, which is produced in the form of an inverting charge amplifier 60 with an input capacitance Ci connected to the (−) terminal thereof and a negative feedback capacitor Cb.

The input impedance of this circuit, as “seen” by the signal to be transmitted, is constituted essentially by the input capacitance Ci. By choosing this very low-value capacitance Ci (a few femtofarads for example) it is possible to obtain a very high input impedance, or in other words corresponding to a leakage capacitance value close to the leakage capacitance already existing between the guard potential 12 and the common ground 13.

By choosing a negative feedback capacitor Cb with a value close to the input capacitance Ci, a follower amplifier is obtained with a gain close to −1, which produces at the output a signal referenced to the common ground 12 which is a true image of the excitation signal E referenced to the guard potential 13. In the embodiment presented, this signal is transmitted to a demodulator 17, for example in order to constitute the carrier signal D.

According to another example, in order to transmit a signal referenced to the common ground 12 to the electronics referenced to the guard potential, it is possible to use a circuit referenced to the guard potential 13 with a very high input impedance.

This solution is shown in FIG. 7. In this embodiment, a command signal h referenced to the common ground 12 is transmitted to the alternating voltage excitation source 15, which is produced with an excitation commutator 20 as described in relation to FIG. 2.

To this end, the command signal h is connected at the input to a follower amplifier 70 referenced to the guard potential 13, which is produced in the form of an inverting charge amplifier 70 with an input capacitance Ci connected to the (−) terminal thereof and a negative feedback capacitor Cb.

As previously, the input impedance of this circuit, as “seen” by the signal to be transmitted, is constituted by the input capacitance Ci. By choosing this very low-value capacitance Ci (a few femtofarads for example) it is possible to obtain a very high input impedance.

By choosing a negative feedback capacitor Cb with a value close to the input capacitance Ci, a follower amplifier is obtained with a gain close to −1, which produces at the output a command signal referenced to the guard potential 13 which is a true image of the command signal h referenced to the common ground 12.

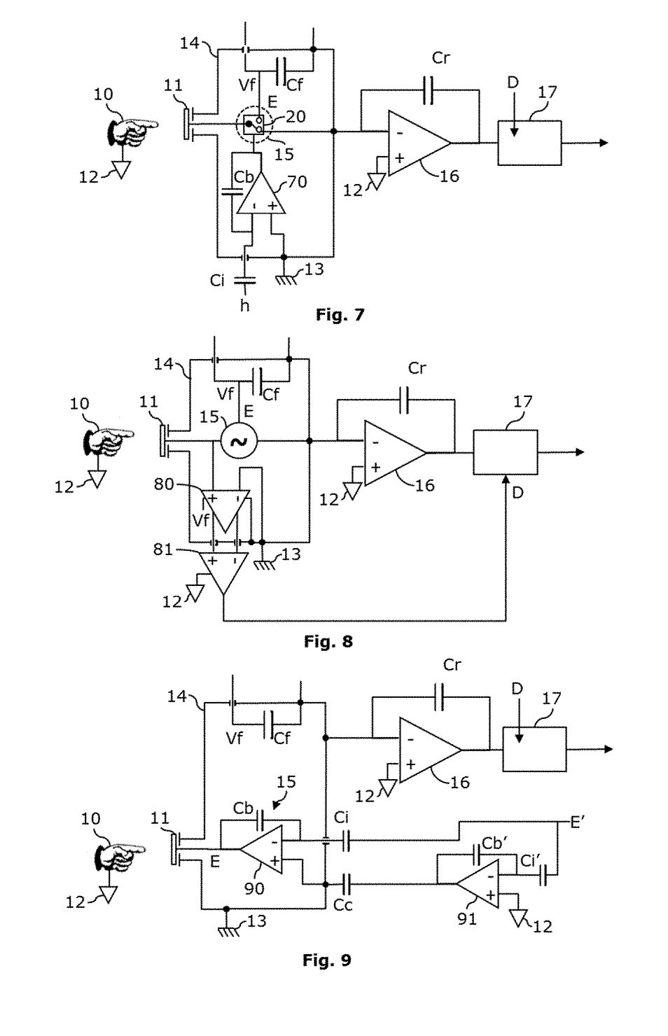

With reference to FIG. 8 and FIG. 9, another solution for transmitting signals between the electronics referenced to the guard potential 13 and the common ground 12 (or vice-versa) consists of generating currents in phase opposition, or flowing in the reverse direction, between the guard potential 13 and the common ground 12. Thus, it is possible to cancel leakage currents almost perfectly, at least at the working frequencies in question.

FIG. 8 shows an embodiment that makes it possible to transmit an excitation signal E to the electronics referenced to the potential of the common ground 12.

The excitation signal E to be transmitted is connected at the input to a first differential amplifier 80 referenced to the guard potential 13. This first differential amplifier 80 is connected at the output to a second differential amplifier 81 referenced to the common ground 12. The first differential amplifier 80 thus supplies a differential signal to the second differential amplifier 81, with two currents that flow via the two inputs of the second differential amplifier 81. These two currents are in phase opposition (at least at the frequencies of the excitation signal E). Thus the residual capacitive leakage created is limited by the difference of these two currents. The use of a second differential amplifier 81 with very high input, very symmetrical impedance makes it possible to limit the residual capacitive leakage very efficiently.

In the embodiment presented, the signal originating from the second differential amplifier 81 is transmitted to a demodulator 17, for example in order to constitute the carrier signal D.

FIG. 9 shows an embodiment that makes it possible to transmit a primary excitation signal E′ generated at the level of the electronics referenced to the potential of the common ground 12 to the alternating voltage excitation source 15.

In this embodiment, the alternating voltage excitation source 15 comprises an excitation amplifier 90 referenced to the guard potential 13, which is produced in the form of an inverting charge amplifier 90 with an input capacitance Ci connected to the (−) terminal thereof and a negative feedback capacitor Cb. This excitation amplifier 90 receives at the input the primary excitation signal E′ referenced to the common ground potential. The (+) terminal thereof is connected to the guard potential 13.

As previously explained, in particular in relation to FIG. 7, the input impedance of this circuit, as “seen” by the primary excitation signal E′, is constituted essentially by the input capacitance Ci. By choosing this very low-value input capacitance Ci (a few femtofarads for example) it is possible to obtain a very high input impedance.

By choosing a negative feedback capacitor Cb with a value close to the input capacitance Ci, an excitation amplifier 90 is obtained with a gain close to −1, which produces at the output an excitation signal E referenced to the guard potential 13 which is a true image of the primary excitation signal E referenced to the common ground 12.

The primary excitation signal is also transmitted at the input of a compensation follower amplifier 91 referenced to the common ground 12. This compensation follower amplifier 91 is produced in the form of an inverting charge amplifier with an input capacitor Ci′ connected to the (−) terminal thereof and a negative feedback capacitor Cb′. The input capacitor Ci′ and the negative feedback capacitor Cb′ are chosen with similar values, so that they behave as a follower amplifier with a gain close to −1.

Thus at the output of the compensation follower amplifier 91 there is a signal corresponding to a replica of the primary excitation signal E′ with a reverse sign or polarity.

This signal supplies a compensation capacitor Cc that connects the output of the compensation follower amplifier 91 to the guard potential 13. This compensation capacitor Cc is chosen with the same value as the input capacitor Ci of the excitation amplifier 90 referenced to the guard potential 13. Ideally, these two capacitors are also produced on the same substrate in order to have characteristics that are as similar as possible.

In this way, a compensation current is generated in the compensation capacitor Cc between the guard potential 13 and the common ground 12 that replicates, with the opposite sign, the current flowing in the input capacitor Ci of the excitation amplifier 90. This compensation current makes it possible to cancel or to compensate for the capacitive leakage due to the current flowing in the input capacitor Ci of the excitation amplifier 90, between the guard potential 13 and the common ground 12. It is thus possible for example to use input capacitors Ci of a higher value than for the embodiment in FIG. 7.

It should be noted that the follower amplifiers described in the embodiments of FIG. 6 to FIG. 9 can also be produced with conventional inverting follower amplifiers with resistors instead of capacitors, (or resistors in parallel with capacitors). However, capacitors have the advantage of being easier to produce than high-value resistors in electronic integrated circuits.

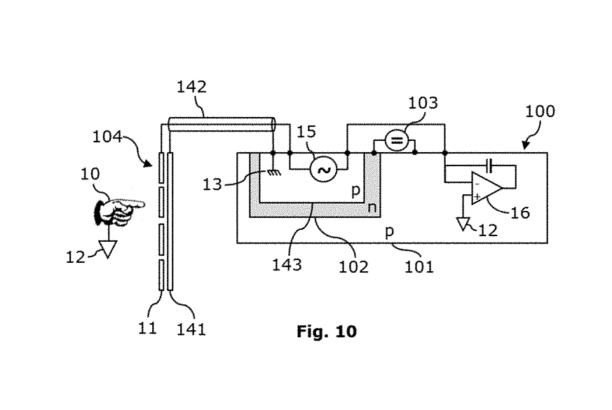

In relation to FIG. 10, an embodiment of the invention in the form of an integrated circuit 100 will now be described. This embodiment is for example particularly suitable for producing a component making it possible to control a large number of capacitive measurement electrodes 11. It can implement all the embodiments previously described in relation to FIGS. 1 to 9.

This integrated circuit 100 is produced for example in CMOS technology.

It comprises a substrate 101, for example with P-type doping. This substrate is referenced to the ground potential 12, which is the reference potential of the power supplies of the integrated circuit 100.

The substrate 101 comprises or supports the part of the electronics referenced to the common ground potential 12, including the current detector 16 or the charge sensitive amplifier 16. It can also comprise the demodulator 17.

The integrated circuit 100 also comprises a guard well 143 electrically isolated from the substrate 101 by an isolation zone 102.

The isolation zone 102 can be produced with an insulating deposit (SiO2).

In the embodiment presented, the isolation zone 102 is produced with at least one PN junction polarized in the barrier direction. More precisely, if the substrate is of the P type, the isolation zone 102 comprises N type doping, and the guard well 143 comprises P type doping. A DC voltage source 103 applies a DC voltage between the substrate 101 and the isolation zone 102, in order to maintain the corresponding PN junction in the barrier direction.

The guard well 143 is electrically connected to the input of the current detector 16. It therefore constitutes guard elements 14 and is referenced to the guard potential 13.

The guard well 143 comprises or supports the electronic elements referenced to the guard potential 13, including the alternating voltage excitation sources 15.

This architecture has the advantage that the guard well 143 produces a very effective guard for protecting the sensitive parts of the electronics. Moreover, the integrated circuit 100 is globally referenced to the common ground 12, and thus easy to incorporate into an electronic system.

The measurement electrodes 11 can for example be produced so as to constitute a sensitive surface 104. In this case, they are protected along their rear face by a guard plane 141. This guard plane 141 is connected to the guard well 143 and thus to the guard potential 13 of the electronics by guard elements 142 that protect the linking tracks for example. The guard plane 141 is of course an element constituting guard elements 14.

Of course, the invention is not limited to the examples that have just been described and numerous amendments may be made to these examples without departing from the scope of the invention.

1. A capacitive detection device, comprising:
at least one capacitive measurement electrode;
a current detector electrically referenced to a common ground and sensitive to an electric current flowing over a measurement input;
at least one alternating voltage excitation source electrically connected or coupled to the measurement input of the current detector and to the at least one capacitive measurement electrode;
guard elements electrically connected or coupled to the measurement input of the current detector;
power supply generation means suitable for generating at least one secondary power supply source referenced to the electrical potential of the guard elements; said power supply generation means also being arranged so as to have, within a frequency band extending from direct current, an impedance between the common ground and the guard elements with a reactive component of a capacitive or essentially capacitive type, or comparable to an open circuit.

2. The device according to claim 1, comprising power supply generation means with electrical switching means.

3. The device according to claim 1, comprising supply generation means with:
a first storage capacitor;
a second storage capacitor connected by a terminal to the guard elements; and
at least two supply commutators arranged so as to connect the terminals of the first storage capacitor respectively either to a primary power supply source
referenced to the common ground potential, or to the terminals of the second storage capacitor.

4. The device according to claim 1, comprising a current detector with a charge sensitive amplifier.

5. The device according to claim 1, comprising an alternating voltage excitation source with at least one of the following elements:
analogue and/or digital electronic excitation means referenced to the potential of the guard elements;
an oscillator;
a digital-to-analogue converter;
a signal generator of the pulse-width modulation type;
a signal generator of the sub-sampling of a master signal type;
an FGPA;
an amplifier or an excitation follower referenced to the potential of the guard elements, and arranged in order to receive at the input a master excitation signal referenced to the common ground potential;
an excitation commutator arranged so as to electrically connect a capacitive measurement electrode either to a secondary power supply source, or to the guard elements or to the measurement input of the current detector.

6. The device according to claim 1, comprising a plurality of capacitive measurement electrodes and commutators making it possible to sequentially connect said capacitive measurement electrodes to the measurement input of the current detector, said commutators being arranged according to one of the following configurations:
the commutators are placed between the measurement electrodes and an alternating voltage excitation source connected to the measurement input of the current detector;
the commutators are placed between alternating voltage excitation sources connected respectively to a measurement electrode and the input of the current detector;
the commutators are placed in alternating voltage excitation sources connected respectively to a measurement electrode or form part of said sources.

7. The device according to claim 1, comprising a plurality of capacitive measurement electrodes and a plurality of alternating voltage excitation sources respectively connected to the capacitive measurement electrodes and to the measurement input of the current detector.

8. The device according to claim 7, comprising a plurality of alternating voltage excitation sources arranged so as to generate excitation signals at frequencies that are different, and/or orthogonal to one another.

9. The device according to claim 1, also comprising demodulation means with at least one of the following elements:
a synchronous demodulator arranged in order to demodulate, with a carrier signal, a modulated measurement signal originating from the current detector;
an amplitude detector;
a digital demodulator.

10. The device according to claim 9, comprising a plurality of alternating voltage excitation sources connected to the measurement input of the current detector and suitable for generating a plurality of excitation signals, and a plurality of synchronous demodulators arranged in order to demodulate a modulated measurement signal originating from the current detector with different carrier signals, said carrier signals and said alternating voltage excitation sources being paired such that a carrier signal makes it possible to selectively demodulate a measurement signal generated by a single alternating voltage excitation source.

11. The device according to claim 9, utilizing a plurality of carrier signals with frequencies that are different, and/or orthogonal to one another.

12. The device according to claim 10, comprising at least one alternating voltage excitation source arranged so as to generate an excitation signal having one of the following forms: sinusoidal, square-wave, and at least one synchronous demodulator with a carrier signal having one of the following forms: sinusoidal, square-wave.

13. The device according to claim 1, comprising signal transfer means suitable for generating a signal referenced to the common ground potential from a signal referenced to the electrical potential of the guard elements, or conversely, said signal transfer means comprise at least one of the following elements:
a follower amplifier produced in the form of an inverting charge amplifier;
an electronic assembly suitable for generating a compensation current between the common ground potential and the electrical potential of the guard elements having a value substantially identical and polarity opposite to a leakage current.

14. The device according to claim 1, comprising an integrated circuit incorporating at least the at least one alternating voltage excitation source, and at least a part of the guard elements.

15. The device according to claim 14, comprising an integrated circuit with guard elements produced in the form of a guard well electrically isolated from the substrate of said integrated circuit, said guard well comprising the at least one alternating voltage excitation source.

16. The device according to claim 15, comprising an integrated circuit with a substrate referenced to the common ground, and a current detector produced on said substrate.

17. The device according to claim 15, comprising an integrated circuit with a guard well electrically isolated from the substrate by one of the following means:
a succession of layers of semi-conductor material with P-type and N-type doping;
at least one layer of insulating materials.

18. An appliance comprising a capacitive detection device according to claim 1.

19. The appliance according to claim 18, comprising a plurality of capacitive electrodes arranged along a surface of said device.

20. The appliance according to claim 18, comprising a plurality of capacitive electrodes superimposed on, or incorporated into, a display screen.
